(19) United States
(12) Patent Application Publication
(10) Pub. No.: US 2017/0219199 A1
(43) Pub. Date: Aug. 3, 2017

(54) HEAT DISSIPATION MODULE FOR LAMP AND LAMP WITH THE SAME

(71) Applicant: SHENZHEN HOLDLED OPTO CO., LTD, Shenzhen (CN)

(72) Inventors: Haifeng Lou, Shenzhen (CN); Lijun Zhou, Shenzhen (CN); Shaopeng Tan, Shenzhen (CN)

(21) Appl. No.: 15/491,968

(22) Filed: Apr. 19, 2017

Related U.S. Application Data
(63) Continuation-in-part of application No. PCT/CN2016/099355, filed on Sep. 19, 2016.

(30) Foreign Application Priority Data
Dec. 8, 2015 (CN) 201521013045.9

(51) Int. Cl. F21V 29/70

(52) U.S. Cl. CPC F21V 29/70

(57) ABSTRACT

The present disclosure relates to an electronic cigarette and an atomizer device and an atomizer assembly thereof. The atomizer assembly includes a connection tube and an inner core assembly arranged in the connection tube. The connection tube defines a liquid inlet hole allowing liquid solution to flow into the connection tube, and the inner core assembly comprises a heater for heating and vaporizing the liquid solution flowed into the connection tube. The connection tube includes a first connection member and a second connection member detachably connected to the first connection member; and the first connection member and the second connection member defines a receiving space in which the inner core assembly is detachably arranged.

### CROSS REFERENCE TO RELATED APPLICATIONS

The present application is a Continuation-In-Part Application of PCT application No. PCT/CN2016/099355 filed on Sep. 19, 2016, which claims the benefit of Chinese Patent Application No. 201521013045.9 filed on Dec. 8, 2015. All the above are hereby incorporated by reference.

### TECHNICAL FIELD

The present disclosure relates to lighting technologies, and more particularly, to a heat dissipation module for lamp and a lamp with the same.

### BACKGROUND

At present, LED lamps such as maize lamps generally have complex structures. In order to dissipate heat effectively, a fan is configured to dissipate the heat generated by the lamp. The configuration of the fan not only increases the difficulty of assembly and manufacture of the lamp, but also increases the hidden danger in safety. When the fan breaks down, the heat cannot be dissipated in time, causing the lamp to be burned out for being too heated.

Heat dissipation bases are provided in some LED lamps for dissipating heat. The heat dissipation base generally has an integral structure formed by extruded aluminum, and a plurality of heat sinks are integrally formed on the heat dissipating base. In this way, the energy generated by the LED lamp is conducted to the middle portion of the heat dissipation base and is conducted to the outer environment, which cannot dissipate the heat effectively.

### BRIEF SUMMARY OF THE DISCLOSURE

The technical problem of the present disclosure is to provide a heat dissipation module for lamp having an improved heat dissipation effect and a lamp with heat dissipation module.

The heat dissipation module for lamp provided in accordance with an embodiment of the present disclosure includes a heat dissipation base and a plurality of heat sinks being relatively independent from the heat dissipation base; the heat dissipation base including a first surface enabling a light source assembly to be mounted on the heat dissipation base and a second surface facing away from the first surface; and the heat sinks being connected on the second surface at intervals.

Preferably, the second surface of the heat dissipation base forms a plurality of positioning slots arranged at intervals, and one end of each of the heat sinks is fixed in the corresponding positioning slot in an interference fit.

Preferably, one end of each of the heat sinks is provided with a protruding connection block for engaging with the corresponding positioning slot; or,

one end of each of the heat sinks is provided with an extending portion extending outwards and being curved at an opposite direction, and the extending portion contacts the end of the corresponding heat sink and engages with the corresponding positioning slot.

Preferably, the first surface of the heat dissipation surface forms a receiving slot for positioning the light source assembly.

Preferably, each of the heat sinks defines at least one through hole.

Preferably, the heat sinks have the same lengths or different lengths.

Preferably, the heat dissipation module further includes at least one connection buckle for connecting the heat sinks together; and the at least one connection buckle is clamped between the heat sinks.

The lamp provided in accordance with an embodiment of the present disclosure includes the heat dissipation module as disclosed above.

Preferably, the lamp further includes a lamp holder and a light source assembly; the heat dissipation module is inserted into the lamp holder through the heat sinks, and the light source assembly is mounted on the heat dissipation base of the heat dissipation module; the at least one through hole of the heat sinks communicates with the lamp holder to form at least one heat dissipation channel.

Preferably, the lamp further includes a lamp head; the lamp head is mounted on at least one end of the lamp holder, and the lamp head is electrically connected to the light source assembly.

Preferably, the lamp further includes a lamp cover covering on a periphery of the lamp holder; or, the lamp cover is engaged on the heat dissipation base and covers on a periphery of the light source assembly.

Preferably, the lamp holder is cylindrical, and the heat dissipation module is arranged on the lamp holder at intervals and corresponds to a periphery of the lamp holder.

As stated above, the heat sinks are physically independent from the heat dissipation base, and the heat sinks and the heat dissipation base are assembled together to dissipate the heat generated by the lamp; compared with the heat dissipation member formed by extruded aluminum, the heat dissipation module of the embodiments of the present disclosure can continuously dissipate the heat during the heat is conducted to the heat dissipation base of the lamp, and the heat won't be concentrated in the heat dissipation base. Thus, the heat dissipation effect is improved.

### BRIEF DESCRIPTION OF THE DRAWINGS

The present disclosure will be described in more detail with reference to the accompany drawings and the embodiments, wherein in the drawings:

FIG. 1 is a schematic view showing a structure of a heat dissipation module for lamp in accordance with a first embodiment of the present disclosure;

FIG. 2 is a schematic view of a heat sink of the heat dissipation module for lamp as shown in FIG. 1;

FIG. 3 is a schematic view showing a structure of a heat dissipation module for lamp in accordance with a second embodiment of the present disclosure;

FIG. 4 is a schematic view of a side surface of a lamp in accordance with a first embodiment of the present disclosure;

FIG. 5 is a schematic view of a top surface of a lamp in accordance with a first embodiment of the present disclosure; and

FIG. 6 is a schematic view of a top surface of a lamp in accordance with a second embodiment of the present disclosure.

### PREFERRED EMBODIMENTS

For clearly understanding technical features, purpose, and effect of the present disclosure, embodiments are given in detail hereinafter with reference to the accompanying drawings.

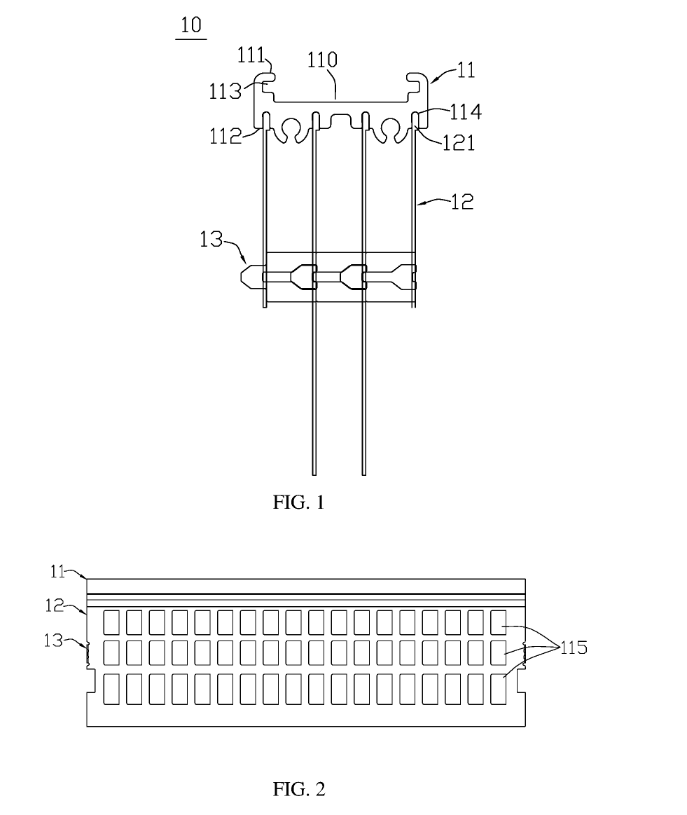

Referring to FIGS. 1 and 2, a heat dissipation module 10 for a lamp in accordance with a first embodiment of the present disclosure includes a heat dissipation base 11 and a plurality of heat sinks 12 being relatively physically independent from the heat dissipation base 11.

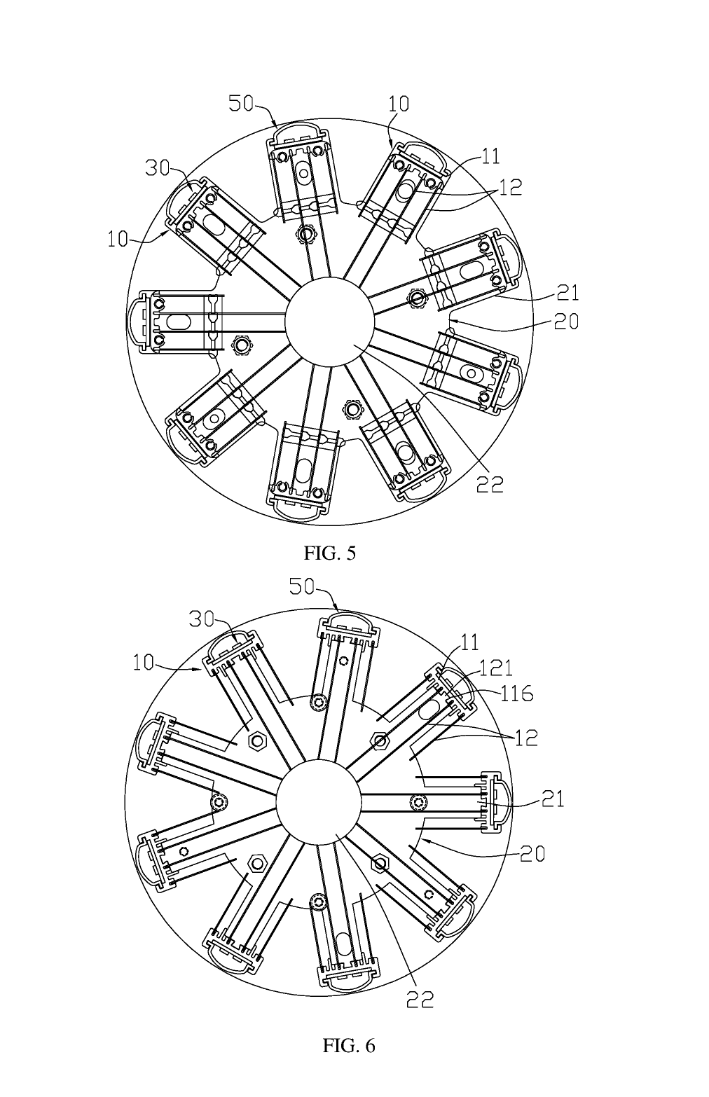

The heat dissipation base 11 includes a first surface 111 and a second surface 112 facing away from the first surface 111. The first surface 111 allows a light source assembly 30 to be mounted thereon (as shown in FIG. 5). The heat sinks 12 are arranged on the second surface 112 at intervals. The energy generated by the light source assembly 30 can be conducted to the heat sinks 12 through the heat dissipation base 11.

The second surface 112 forms a plurality of spaced positioning slots 114 which are capable of engaging with the heat sinks 12. The number of the positioning slots 114 can be greater than or equal to that of the heat sinks 12.

The first surface 111 of the heat dissipation base 11 forms a receiving slot 110 and a clamping slot 113. The receiving slot 110 is used for receiving and positioning the light source assembly 30. The clamping slot 113 enables a lamp cover 50 to be clamped onto the light source assembly 30.

The second surface 112 of the heat dissipation base 11 forms a plurality of positioning slots 114 arranged at intervals. The positioning slots 114 are capable of engaging with the heat sinks 12. The number of the positioning slots 114 is equal to or greater than that of the heat sinks 12. Spare positioning slots 14 can be used as heat dissipation slots to increase the heat dissipation area of the heat dissipation base 11, thereby improving the heat dissipation effect. The shape of the individual heat dissipation slot can be identical to that of the corresponding positioning slot 114 engaging with the heat sink 12. In other embodiments, the shape of the heat dissipation slot also can be different from that of the corresponding positioning slot 114, for example, the heat dissipation slot can be a circular slot.

The heat dissipation module 10 is integrally formed by metal which is capable of dissipating heat, such as aluminum. The heat dissipation base 11 and the heat sinks 12 can be formed through extruded aluminum respectively. The receiving slot 110 and the positioning slots 114 can be integrally formed on the heat dissipation base 11.

As shown in FIG. 2, the heat sink 12 defines at least one through hole 115, which improves the heat dissipation effect. The through hole 115 can be polygonal or circular, etc. In this embodiment, the plurality of through holes 115 are arranged in the heat sink 12 in rows and columns.

Optionally, one end of the heat sink 12 is in an interference fit with the corresponding positioning slot 114.

One end of each of the heat sinks 12 is provided with a connection block 121 protruding from the end for engaging within the corresponding positioning slot 114. The connection block 121 can be integrally formed with the heat sink 12. A width of the connection block 121 is greater than or equal to that of the corresponding positioning slot 114. During assembly, the connection block 121 of the heat sink 12 is pressed into the positioning slot 114 such that the connection block 121 can be fixed within the positioning slot 114 in an interference fit.

On the heat dissipation base 11, the heat sinks 12 can extend outwards for the same lengths or different lengths. At least one of the heat sinks 12 can be clamped to a lamp holder, thereby fixing the heat dissipation base 10 to the lamp holder.

Referring to FIGS. 1 and 2, the heat dissipation module 10 further includes a plurality of connection buckles 13 for connecting the heat sinks 12 together. The connection buckles 13 are clamped between the heat sinks 12 so as to improve the stabilities between the heat sinks 12.

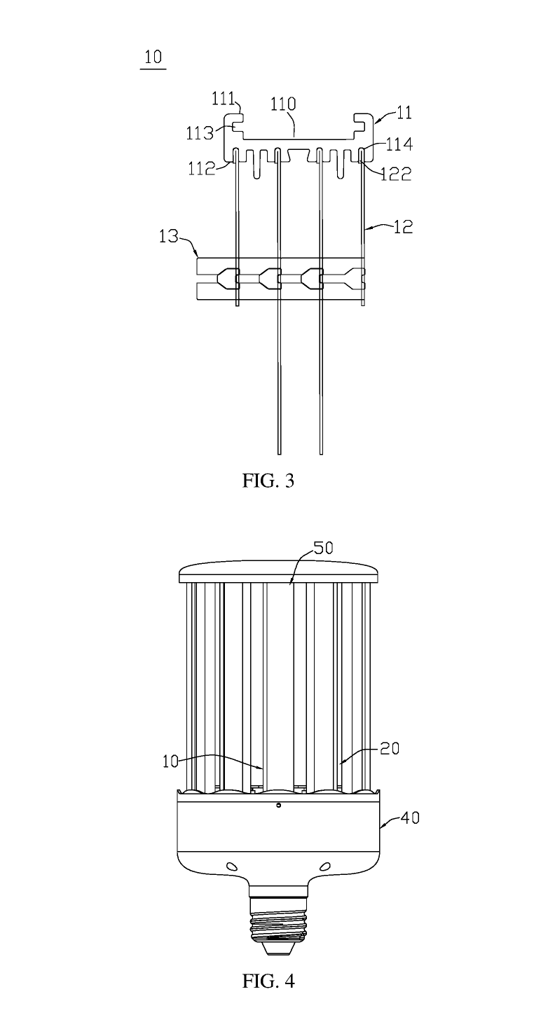

Referring to FIG. 3, a heat dissipation module 10 for a lamp in accordance with a second embodiment includes a heat dissipation base 11 and a plurality of heat sinks 12 being relatively independent from the heat dissipation base 11.

The heat dissipation base 11 includes a first surface 111 and a second surface 112 facing away from the first surface 111. The first surface 111 enables a light source assembly 30 (as shown in FIG. 6) to be mounted on the heat dissipation base. The heat sinks 12 are arranged on the second surface 112 at intervals. The energy generated by the light source assembly 30 is conducted to the heat sinks 12 through the heat dissipation base 11.

The first surface 111 of the heat dissipation base 11 forms a receiving slot 110 and a clamping slot 113. The receiving slot 110 is used for receiving and positioning the light source assembly 30. The clamping slot 113 enables a lamp cover 50 to be clamped onto the light source assembly 30.

The heat dissipation module 10 further includes a plurality of connection buckles 13 for connecting the heat sinks 12 together. The connection buckles 13 are clamped between the heat sinks 12 so as to improve the stabilities between the heat sinks 12.

Arrangement of the through holes defined in the heat sink 12 can be referred to FIG. 2.

The difference between the second embodiment and the first embodiment lies in that: in the second embodiment, one end of the heat sink 12 is provided with an extending portion 122 extending outwards and being curved at an opposite direction. The extending portion 122 contacts the end of the corresponding heat sink 12, allowing the end of the heat sink 12 to form a fixing end. Optionally, a width of the positioning slot 114 is no greater than a thickness of the fixing end. In assembly, the fixing end of the heat sink 12 is pressed into the positioning slot 114 to be fixed within the positioning slot in an interference fit.

Referring to FIG. 4, a lamp in accordance with an embodiment of the present disclosure includes a heat dissipation module 10 which improves the heat dissipation effect of the lamp.

Referring to FIGS. 4 to 6, the lamp further includes a lamp holder 20, a light source assembly 30, and a lamp head 40. The heat dissipation module 10 is inserted into the lamp holder 20, and the light assembly 30 is mounted on the heat dissipation module 10. The lamp head 40 is mounted on at least one end of the lamp holder 20 and is electrically connected to the light source assembly 30. The light source assembly 30 includes a lamp panel and LED lamp beads. The LED lamp beads are arranged on the lamp panel and are electrically connected to the lamp panel.

Furthermore, according to requirements, the lamp can further include a lamp cover 50 covering on a periphery of the light source assembly 30 for improving the light emission effect and protecting the light source assembly 30.

Referring to FIG. 5, a lamp in accordance with a first embodiment includes at least one of the heat dissipation module 10 as shown in FIG. 1. The heat dissipation module 10 is inserted into the lamp holder 20 through the heat sinks 12. The light source assembly 30 is mounted on the heat dissipation base 22 of the heat dissipation module 10 and is received in the receiving slot 110. The lamp cover 50 engages with the heat dissipation base 11, covering on the periphery of the light source assembly 30. Two sides of the light cover 50 are clamped into the clamping slot 113 formed in the heat dissipation base 11. The light source assembly 30 is located between the lamp cover 50 and the heat dissipation base 11.

The lamp holder 20 further includes at least one protruding positioning portion 21 which enables the heat dissipation module 10 to be mounted on the lamp holder 20. The shape of the positioning portion 21 is not limited herein.

Referring to FIGS. 2 and 5, the lamp holder 20 forms a center channel 22. The center channel 22 communicates with the through holes 115 defined in the heat sinks 12 to form heat dissipation channels, further improving the heat dissipation effect of the lamp.

Referring to FIG. 6, a lamp in accordance with a second embodiment includes at least one of the heat dissipation module 10 as shown in FIG. 3. The heat dissipation module 10 is inserted into the lamp holder 20 through the heat sinks 12. The light source assembly 30 is mounted onto the heat dissipation base 11 and is received in the receiving slot 110. The lamp cover 50 engages with the heat dissipation base 22, covering on the periphery of the light source assembly 30. Two sides of the lamp cover 50 can be clamped into the clamping slot 113. The light source assembly 30 is located between the lamp cover 50 and the heat dissipation base 11.

The lamp holder 20 further includes at least one protruding positioning portion 21 allowing the heat dissipation module 10 to be mounted on the lamp holder 20. The heat sinks 12 can be located at two sides of the corresponding positioning portion 21 or inserted into the positioning portion 21, such that the heat sinks 12 can be fixed to the lamp holder 20. In this embodiment, one end of each of the positioning portion 21 facing the heat dissipation base 11 is provided with a clamping portion 211. The clamping portion 211 is clamped into a corresponding clamping slot 116 formed in the heat dissipation base 11.

The lamp holder 20 forms a center channel 22. The center channel 22 communicates with the through holes 115 defined in the heat sinks to form heat dissipation channels, further improving the heat dissipation effect of the lamp.

In the above first and second embodiments of the lamp, the number of the lamp cover 50 is equal to that of the heat dissipation module 10.

The lamp holder 20 can be cylindrical. The at least one of heat dissipation module 10 corresponds to a periphery of the lamp holder 20 and is arranged on the lamp holder at intervals. Optionally, the lamp can be a maize lamp. Multiple heat dissipation modules 10 surround the periphery of the lamp holder 20 as a circular and are arranged at intervals. Multiple light source assemblies 30 are mounted on the heat dissipation bases 12 respectively. The lamp covers 50 engage with the heat dissipation bases 12 respectively for covering the light source assemblies 30.

In other embodiments, the lamp cover 50 is arranged corresponding to the lamp holder 20. The lamp cover 50 is substantially cylindrical and covers on the periphery of the lamp holder 20.

The contents described above are only preferred embodiments of the present disclosure, but the scope of the present disclosure is not limited to the embodiments. Any ordinarily skilled in the art would make any modifications or replacements to the embodiments in the scope of the present disclosure, and these modifications or replacements should be included in the scope of the present disclosure. Thus, the scope of the present disclosure should be subjected to the claims.

What is claimed is:

1. A heat dissipation module for lamp, comprising: a heat dissipation base and a plurality of heat sinks being relatively independent from the heat dissipation base; the heat dissipation base comprising a first surface enabling a light source assembly to be mounted on the heat dissipation base and a second surface facing away from the first surface; and the heat sinks being connected on the second surface at intervals.

2. The heat dissipation module for lamp as claimed in claim 1, wherein the second surface of the heat dissipation base forms a plurality of positioning slots arranged at intervals, and one end of each of the heat sinks is fixed in the corresponding positioning slot in an interference fit.

3. The heat dissipation module for lamp as claimed in claim 2, wherein one end of each of the heat sinks is provided with a protruding connection block for engaging with the corresponding positioning slot; or,
one end of each of the heat sinks is provided with an extending portion extending outwards and being curved at an opposite direction, and the extending portion contacts the end of the corresponding heat sink and engages with the corresponding positioning slot.

4. The heat dissipation module for lamp as claimed in claim 1, wherein the first surface of the heat dissipation surface forms a receiving slot for positioning the light source assembly.

5. The heat dissipation module for lamp as claimed in claim 1, wherein each of the heat sinks defines at least one through hole.

6. The heat dissipation module for lamp as claimed in claim 1, wherein the heat sinks have the same lengths or different lengths.

7. The heat dissipation module for lamp as claimed in claim 1, further comprising: at least one connection buckle for connecting the heat sinks together; and the at least one connection buckle is clamped between the heat sinks.

8. A lamp, comprising a heat dissipation module and a light source assembly; the heat dissipation module comprising: a heat dissipation base and a plurality of heat sinks being relatively independent from the heat dissipation base; the heat dissipation base comprising a first surface enabling the light source assembly to be mounted on the heat dissipation base and a second surface facing away from the first surface; and the heat sinks being connected on the second surface at intervals.

9. The lamp as claimed in claim 8, wherein the lamp further comprises a lamp holder; the heat dissipation module is inserted into the lamp holder through the heat sinks, the at least one through hole of the heat sinks communicates with the lamp holder to form at least one heat dissipation channel.

10. The lamp as claimed in claim 9, wherein the lamp further comprises a lamp head; the lamp head is mounted on at least one end of the lamp holder, and the lamp head is electrically connected to the light source assembly.

11. The lamp as claimed in claim 9, wherein the lamp further comprises a lamp cover covering on a periphery of the lamp holder; or, the lamp cover is engaged on the heat dissipation base and covers on a periphery of the light source assembly.

12. The lamp as claimed in claim 9, wherein the lamp holder is cylindrical, and the heat dissipation module is arranged on the lamp holder at intervals and corresponds to a periphery of the lamp holder.

13. The lamp as claimed in claim 8, wherein the second surface of the heat dissipation base forms a plurality of positioning slots arranged at intervals, and one end of each of the heat sinks is fixed in the corresponding positioning slot in an interference fit.

14. The lamp as claimed in claim 13, wherein one end of each of the heat sinks is provided with a protruding connection block for engaging with the corresponding positioning slot; or,
one end of each of the heat sinks is provided with an extending portion extending outwards and being curved at an opposite direction, and the extending portion contacts the end of the corresponding heat sink and is engaged within the corresponding positioning slot.

15. The lamp as claimed in claim 8, wherein the first surface of the heat dissipation surface forms a receiving slot for positioning the light source assembly.

16. The lamp as claimed in claim 8, wherein the heat sinks define at least one through hole.

17. The lamp as claimed in claim 8, wherein the heat sinks have the same lengths or different lengths.

18. The lamp as claimed in claim 8, further comprising: at least one connection buckle for connecting the heat sinks together; and the at least one connection buckle is clamped between the heat sinks.
